(19) United States
(12) Patent Application Publication
(10) Pub. No.: US 2021/0273226 A1
(43) Pub. Date: Sep. 2, 2021

(54) SECONDARY BATTERY USING RADICAL POLYMER IN AN ELECTRODE

(71) Applicant: NEC Corporation, Minato-ku, Tokyo (JP)

(72) Inventors: Shigeyuki IWASA, Tokyo (JP); Takanori NISHI, Tokyo (JP); Momotaro TAKEDA, Okayama (JP); Hideharu IWASAKI, Okayama (JP)

(73) Assignee: NEC Corporation, Minato-ku, Tokyo (JP)

(21) Appl. No.: 17/260,644

(22) PCT Filed: Jul. 19, 2019
(86) PCT No.: PCT/JP2019/028432

§ 371 Date: Jan. 15, 2021

(30) Foreign Application Priority Data
Jul. 19, 2018 (JP) 2018-135495

(51) Int. Cl. H01M 4/60; C08F 220/18

(52) U.S. Cl. CPC H01M 4/608; H01G 11/30; C08F 220/1818

(57) ABSTRACT

In order to provide an organic radical battery having excellent high power, discharge characteristics at a high current, and cycle characteristics, an electrode having a repeating unit having a nitroxide radical site represented by formula (1-a) and a repeating unit having a carboxyl group represented by formula (1-b) in a range in which x satisfies 0.1 to 10 and using a copolymer having a cross-linked structure as an electrode active material is used for the organic radical battery.

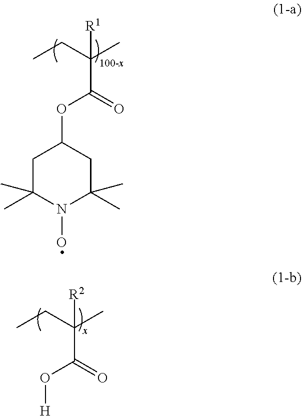

(wherein in Formulas (1-a) and (1-b), R¹ and R² each independently represent hydrogen or a methyl group; and x represents a mol % of Formula (1-b) in the total 100 mol % of Formulas (1-a) and (1-b).)

### TECHNICAL FIELD

The present invention relates to a secondary battery using a radical polymer as an electrode active material.

### BACKGROUND ART

In the 1990s, mobile phones rapidly became popular with the development of communication systems. From the 2000s, a wide variety of portable electronic devices such as notebook computers, tablet terminals, smart-phones, and portable game machines have spread. The portable electronic devices are indispensable for businesses and daily lives. For power sources of the portable electronic devices, secondary batteries are used. The secondary batteries are always demanded to have a high energy density meaning that one-time charge allows long usage thereof. On the other hand, the portable electronic devices are, since diversification of functions and shapes thereof is advancing, increasingly demanded to have various properties such as high output, large current discharge (high rate discharge), short time charge (high rate charge), size reduction, weight reduction, flexibility and high safety.

Patent Literature 1 discloses a secondary battery utilizing redox of a stable radical compound for charge and discharge. The secondary battery is one called an organic radical battery. The stable radical compound is, since being an organic material constituted of light-weight elements, expected as a technology providing light-weight batteries. Non-Patent Literature 1 and Non-Patent Literature 2 report that organic radical batteries can be charged and discharged at large currents and have high power densities. In addition, Non-Patent Literature 2 also describes that the organic radical battery can be reduced in thickness and has flexibility.

In an organic radical batteries, a radical polymer having a stable radical such as poly(2,2,6,6-tetramethylpiperidinyl-N-oxyl-4-yl methacrylate) (PTMA) (Formula (2)) is used as an electrode active material.

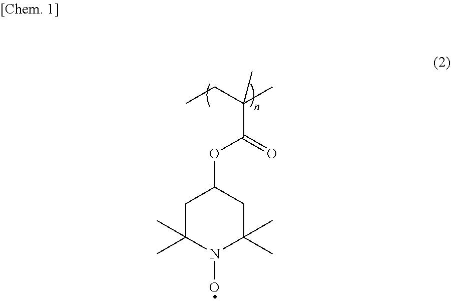

Although PTMA has nitroxyl radicals as stable radical species, nitroxyl radicals adopt oxoammonium cation structures in the charged state (oxidized state) and nitroxyl radical structures in the discharged state (reduced state). Then, the redox reaction (Reaction Scheme (I)) thereof can be stably repeated. By utilizing this redox reaction, the organic radical battery can repeat charging and discharging.

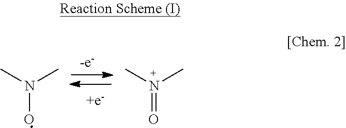

In conventional secondary batteries such as Li ion batteries, lead storage batteries, and nickel metal hydride batteries, heavy metal materials and carbon materials have been used as electrode active materials. These electrode active materials, though having wettability to electrolyte, do not absorb the electrolyte themselves and then never change to a flexible state. On the other hand, Non-Patent Literature 2 describes that PTMA (Formula (2)) being an electrode active material of the organic radical battery, since having high affinity for an organic solvent, absorbs an electrolyte and becomes gel in the battery. In addition, Non-Patent Literature 3 reports that the gel has a charge transport ability by charge self-exchange between a nitroxyl radical and an oxoammonium ion.

Patent Literature 2 discloses a piperidyl group-containing high molecular weight polymer or a copolymer having a structure represented by the following general Formula (3) or the following general Formula (4) as a nitroxyl radical-containing compound. However, in examples, PTMA of the above Formula (2) (in the following Formula (3), m=0, X₁=—COO—, R₄=—H, R₅=—CH₃) is only shown.

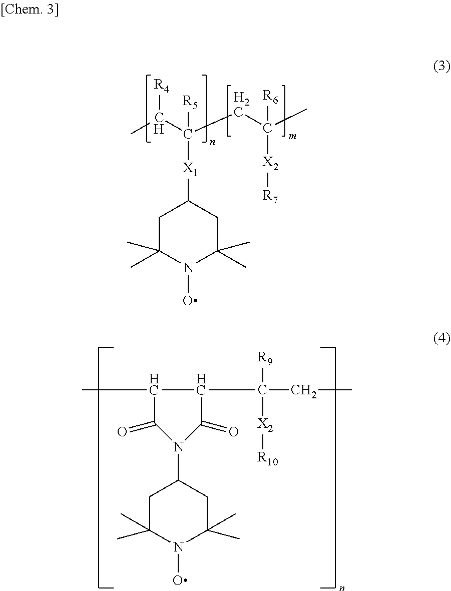

(Wherein in Formulas, R₄ represent —H, —CH₃ or —COOLi, R₅, R₆, and R₉ represent —H or —CH₃, R₇ and R₁₀ represent —H, alkali metal, C₁₋₅₀ alkyl group, C₁₋₅₀ alkenyl group, C₁₋₅₀ aralkyl group, and halogen-substituted C₁₋₅₀ alkyl group, X1 and X2 represent a direct bond, —CO—, —COO—, —CONR8-, —O—, —S—, alkylene group optionally having substituents, arylene group optionally having substituents, a divalent group combining two or more of these groups. R8 represents hydrogen atom or C1-18 alkyl group. n represents a number of 30 or more, and m represents 0 or a positive number.)

Non-Patent Literature 5 is described that the cycle characteristic is improved by modifying PTMA into a crosslinked structure. As a reason for improving the cycle characteristic, it has been described that uncrosslinked PTMA gel in the electrode leads a change in the shape of the microstructure due to having fluidity, but its fluidity is suppressed by forming a crosslinked structure.

### CITATION LIST

### Patent Literature

Patent Literature 1: JP 2002-304996 A

Patent Literature 2: JP 2007-213992 A

### Non-Patent Literature

Non-Patent Literature 1: Nakahara and five others, Journal of Power Sources, Vol. 163, pp. 1110-1113 (2007)

Non-Patent Literature 2: Iwasa and three others, NEC Technical Journal, Vol. 7, pp. 105-106 (2012)

Non-Patent Literature 3: Nakahara and two others, Journal of Material Chemistry, Vol. 22, pp. 13669-133664 (2012)

Non-Patent Literature 4: Iwasa and two others, Journal of Electroanalytical Chemistry, Vol. 805, pp. 171-176 (2017)

Non-Patent Literature 5: Iwasa and three others, Journal of Electrochemical Society, Vol. 164, pp. A884-A888 (2017)

### SUMMARY OF INVENTION

### Technical Problem

The charge and discharge mechanism of a positive electrode of a PTMA organic radical battery is shown in FIG. 1. On the surface of the current collector or carbon (conductivity additive) in contact with PTMA gel, a redox reaction shown in Reaction Scheme (I) occurs, and at this time, electron transfer is performed between PTMA and the current collector or carbon. Here, the surface condition of PTMA gel greatly affects the adhesion to the current collector or the carbon (conductivity additive). The ease of transfer of electrons, i.e., the ease of transfer of charges between PTMA and the current collector or carbons, is believed to be greatly affected by this adhesion.

Simultaneously with the transfer of electrons between PTMA and the current collector or carbon, in PTMA gels, charge transportation occurs to deliver reactive species to the surface of the current collector or carbon. This charge transportation is a key point of the charge and discharge mechanism of the positive electrode of the organic radical battery using PTMA. Because of the diffusion phenomenon caused by the concentration gradient, this rate is considered to be relatively slow. The slowness of charge transportation in PTMA gels is a factor that lowers the discharge characteristics of organic radical batteries at high power and high current, which are inherent in organic radical batteries. Then, it is considered that the state of PTMA gels greatly affects this transportation speed (charge transport ability). It is believed that the state of PTMA gels can be varied due to the solvents to be swollen and structural improvements of the polymers themselves. In Non-Patent Literature 4, it is described that the type of solvent in which PTMA is swollen affects the diffusion coefficient (an index of the charge transport ability) of PTMA gel.

When the copolymer described in Patent Literature 2 was examined, it was confirmed that the output characteristic was improved, but there was room for further improvement in terms of achieving both the discharge characteristic and the cycle characteristic at a large current.

It is an object of the present invention to simultaneously improve adhesion and charge transporting ability by introducing a carboxyl group into the structure of a radical polymer compound, and to further introduce a cross-linking structure into the radical polymer compound, thereby achieving both discharge characteristics at a high current, that is, high output characteristics and cycle characteristics of an organic radical battery.

### Solution to Problem

As described above, by introducing the carboxyl group into PTMA, the charge transporting ability in the gels and the adhesion to the current collector or carbon can be simultaneously improved, and the performance related to high power, large current discharging, and short-time charging of the organic radical batteries can be expected to be improved. However, when a carboxyl group which is a polar group is introduced, an electrolytic solution composed of a highly polar solvent is easily absorbed. This makes it easier for PTMA gels to change in shape in the electrode, thus reducing the cycle characteristics. However, this change in the shape of PTMA gel can be suppressed by further making PTMA into a crosslinked structure into which a carboxyl group is introduced.

The inventors have found that by introducing a carboxyl group into a polymer radical compound such as PTMA and forming a cross-linked structure, the organic radical battery excellent in cycle characteristics can be obtained while improving high power, high current discharging performance, and short-time charging performance of the organic radical battery.

In other words, according to one aspect of the present invention, provided is an electrode using, as an electrode active material, a copolymer having a repeating unit having a nitroxide radical site represented by the following Formula (1-a) and a repeating unit having carboxyl group represented by the following Formula (1-b) in the range of x satisfying 0.1 to 10, and the copolymer having a crosslinked structure.

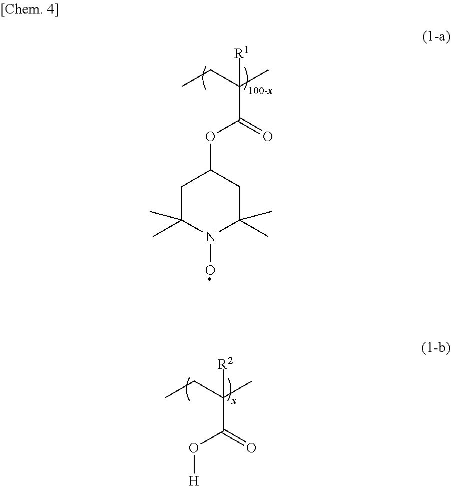

(wherein in Formulas (1-a) and (1-b), R¹ and R² each independently represent hydrogen or a methyl group; and x represents a mol % of Formula (1-b) in the total 100 mol % of Formulas (1-a) and (1-b).)

In addition, the cross-linked structure is preferably at least one of the crosslinked structural units represented by the following Formulas (1-c) and (1-d).

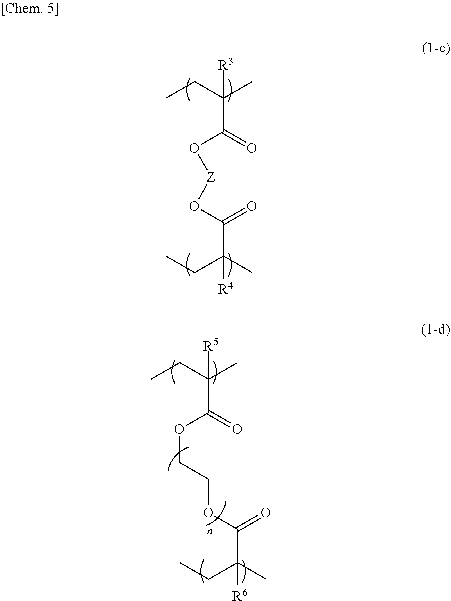

(wherein in Formulas (1-c) and (1-d), R³ to R⁶ each independently represent hydrogen or a methyl group; Z represents an alkylene chain having 2 to 12 carbon atoms and n represents an integer of 1 to 12.)

Further according to another aspect of the present invention, provided is a secondary battery using the above electrode for a positive electrode or a negative electrode, or for both positive and negative electrodes.

### Advantageous Effects of Invention

According to the present invention, an “organic radical battery” excellent in high output power and discharge rate characteristics can be obtained.

### BRIEF DESCRIPTION OF DRAWINGS

FIG. 1 is a conceptual diagram of the charge and discharge mechanism of a positive electrode of a conventional organic radical battery.

FIG. 2 is a perspective view of a laminate-type secondary battery according to an example embodiment.

FIG. 3 is a cross-sectional view of the laminate-type secondary battery according to the example embodiment.

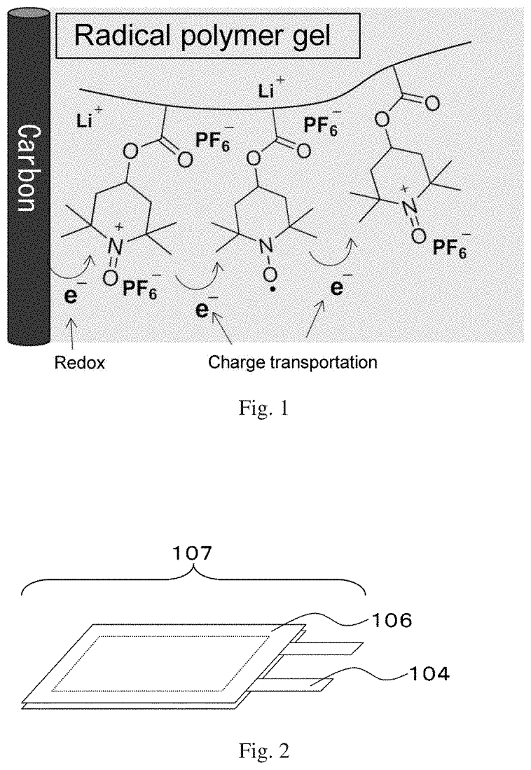

### DESCRIPTION OF EMBODIMENTS

Hereinafter, an electrode and a secondary battery using the electrode active material according to the present invention will be described by way of example embodiments. The present invention, however, is not limited to the following description, and any changes and modifications may be made in the scope not departing from the gist of the present invention.

[Polymer Radical Compounds]

In the electrode according to the present invention, the electrode active material has a repeating unit having a nitroxide radical site represented by the following Formula (1-a) and a repeating unit having a carboxyl group represented by the following Formula (1-b) in a range in which x satisfies 0.1 to 10, and also contains a copolymer having a crosslinked structure (hereinafter, referred to as a “crosslinked copolymer”)

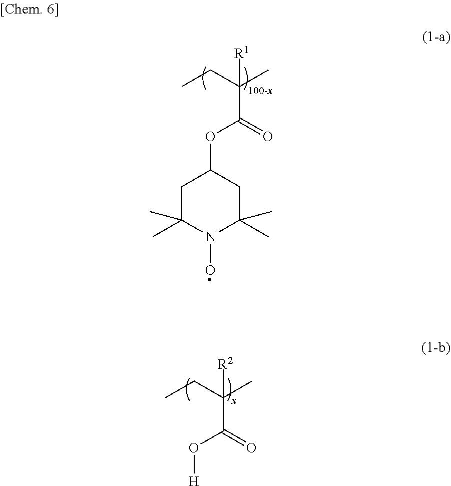

(wherein in Formulas (1-a) and (1-b), le and R² each independently represent hydrogen or a methyl group; and x represents a mol % of Formula (1-b) in the total 100 mol % of Formulas (1-a) and (1-b).)

When the total amount of the repeating unit having a nitroxide radical site represented by

Formula (1-a) and the repeating unit having a carboxyl group represented by Formula (1-b) is set to 100 mol %, when the repeating unit of Formula (1-b) is contained in an amount of more than 10 mol %, the proportion of the repeating unit of Formula (1-a) becomes low, resulting in a decrease in battery capacity. On the other hand, when the repeating unit of Formula (1-b) is less than 0.1 mol %, the effect of modifying the gel state cannot be expected.

The proportion (x) of the repeating unit of Formula (1-b) is preferably 0.5 mol % or more, more preferably 1.0 mol % or more. Further, the ratio (x) is preferably 5.0 mol % or less, more preferably 2.0 mol % or less.

The crosslinked copolymer according to the present invention includes a unit derived from a polyfunctional monomer (referred to as a crosslinked structural unit) capable of forming a crosslinked structure in addition to the Formulas (1-a) and (1-b) as a constitutional unit. The other repeating units may be contained within a range not impairing the effect of the present invention. Examples of the other constitutional unit include non-ionized repeating units such as alkyl (meth)acrylate. By using a crosslinked copolymer, elution into an electrolytic solution when used for a long time can be suppressed. Further, by using the cross-linked copolymer, it is possible to provide an organic radical battery having excellent discharge characteristics, particularly high current discharge characteristics. In other words, crosslinking can improve durability to the electrolyte solution, resulting in a secondary battery excellent in long-term reliability. The crosslinked structure and other constitutional units are preferably 5 mol % or less, more preferably 1 mol % or less, based on 100 mol % of the total of the repeating units of the Formulas (1-a) and (1-b). In particular, it does not contain other constitutional units, and the crosslinked structural unit is preferably 5 mol % or less, more preferably 1 mol % or less, based on 100 mol % of the total of the repeating units of the Formulas (1-a) and (1-b).

As the crosslinked structural unit, at least one of the crosslinked structural units represented by the following Formulas (1-c) and (1-d) is preferred.

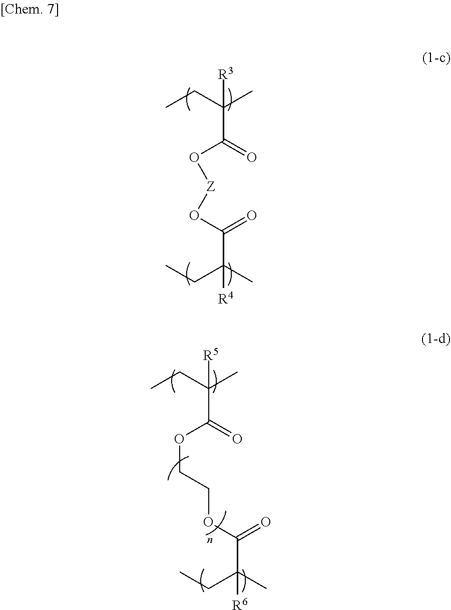

(wherein in Formulas (1-c) and (1-d), R³ to R⁶ each independently represent hydrogen or a methyl group; Z represents an alkylene chain having 2 to 12 carbon atoms and n represents an integer of 1 to 12.)

As the polyfunctional monomer capable of forming the crosslinked structural unit of the above Formulas (1-c) and (1-d), a bifunctional (meth) acrylate represented by the following Formulas (5) and (6) can be used. A polyfunctional monomer capable of forming a crosslinked structural unit may be referred to as a “crosslinking agent”

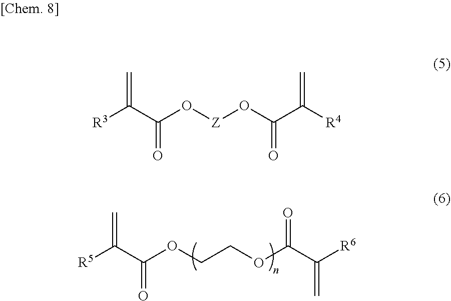

Although there is no particular limitation on the molecular weight of the crosslinked copolymer according to the present invention, it is preferable that the crosslinked copolymer has a molecular weight which is only insoluble in the electrolytic solution when the secondary battery is configured. The molecular weight which is not soluble in the electrolytic solution varies depending on the combination with the type of the organic solvent in the electrolytic solution, but is generally a weight average molecular weight of 1000 or more, preferably 10,000 or more, and more preferably 20,000 or more. In addition, in the case of a very high molecular weight, since the polymer cannot absorb the electrolytic solution and does not become a gel, it is preferable to have a molecular weight of 1,000,000 or less, more preferably 200,000 or less. The weight average molecular weight can be measured by a known method such as gel permeation chromatography (GPC) In addition, when it is not dissolved in GPC solvent, it may be considered molecular weight according to the degree of crosslinking from the weight average molecular weight of the corresponding linear copolymer.

An example of a method for synthesizing a crosslinked copolymer of the present invention will be described using the following Reaction Scheme II

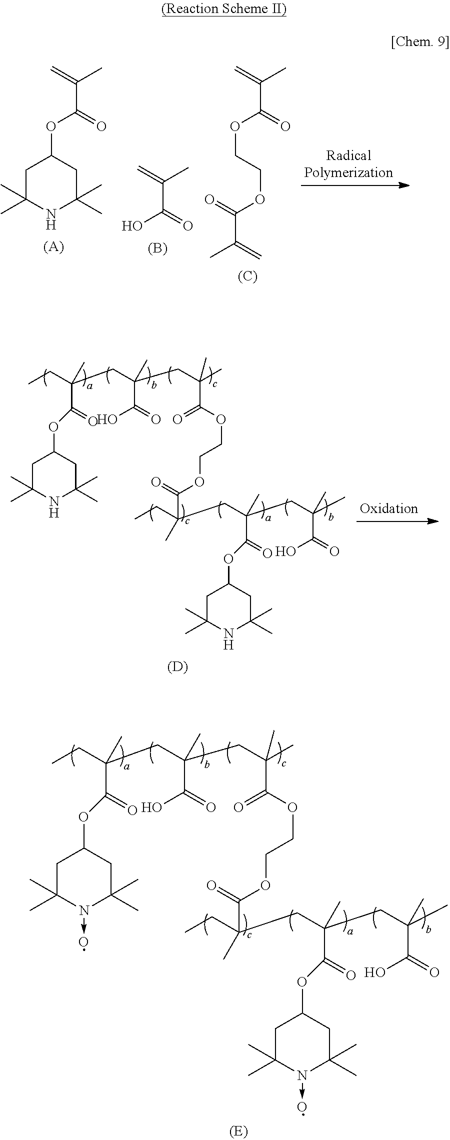

A crosslinking copolymer of Formula (D) is obtained by radically copolymerizing a methacrylate having a secondary amine (Formula (A)), methacrylic acid (B) and a crosslinking agent (C) capable of forming a crosslinked structure corresponding to the above Formula (1-c) in the presence of a water-soluble radical polymerization initiator such as potassium persulfate or a surfactant such as dodecylbenzene sulfonic acid in a hydrophilic solvent such as water or methanol. At this time, the molar ratios of the methacrylate (A) having a secondary amine, the methacrylic acid (B), and the crosslinking agent (C) are set to be the same as the molar ratios a, b, and c of the repeating units of the copolymer. Next, by oxidizing the secondary amine site of the copolymer represented by Formula (D) with an oxidizing agent such as hydrogen peroxide water or metachloroperbenzoic acid, it is converted into a nitroxide radical to obtain a crosslinked copolymer represented by Formula (E). Note that the crosslinked structures in the crosslinked copolymers represented by Formula (D) and Formula (E) are exemplarily shown, and it is obvious to those skilled in the art that the crosslinked structure can be formed at any position.

As a form of the crosslinked copolymer, any of a random copolymer and a block copolymer is possible, but a crosslinked copolymer in which a repeating unit of the Formula (1-b) is contained with dispersing is preferred. Further, since the proportion of the repeating unit of Formula (1-b) is small, it may be reacted with the precursor monomer of Formula (1-b) and the crosslinking agent from the prepolymer having the repeating unit of the precursor structure of Formula (1-a)

The crosslinked copolymer according to the present invention may be used only in a positive electrode as an electrode active material, or only in a negative electrode, or may be used in both a positive electrode and a negative electrode. However, the oxidation-reduction potential of the nitroxide radical in the cross-linked copolymer according to the present example embodiment is around 3.6V versus Li/Li⁺. This is a relatively high potential, and an organic radical battery having a high voltage can be obtained by using this as a positive electrode and combining it with a negative electrode having a low potential. Therefore, it is preferable that the crosslinked copolymer according to the present invention is used for a positive electrode as a positive electrode active material.

The crosslinked copolymer according to the present invention is obtained in a gel solid state by polymerization in a solvent. When used as an electrode active material, a solvent in the gel is usually removed and used after being powdered, but it may be used in a slurry preparation as a gel.

In the case of a powdery state, as the particle diameter of the crosslinked copolymer is, the smaller the particle diameter is preferable, because it is related to the charge transfer distance in the gel. However, when the particle diameter becomes smaller than necessary, handling of the polymerized product becomes difficult. In addition, it is preferable to optimize the particle diameter because the cohesive force becomes strong during use, making it difficult to form an electrode, and furthermore, it becomes difficult to transfer charges. As the particle diameter (primary average particle diameter) of the crosslinked copolymer, a range of 0.01 μm to 50 μm is preferred, a range of 0.02 μm to 45 μm is more preferred, and a range of 0.05 μm to 30 μm is optimal.

Next, the configuration of each part of the secondary battery will be described.

(1) Electrode Active Material

The electrode active material using the crosslinked copolymer according to the present invention can be used in either one of the positive electrode and the negative electrode of the secondary battery, or both of the electrodes. In the electrode (positive electrode and negative electrode) of the secondary battery, the electrode active material of the present invention may be used alone or in combination with other active materials. When the electrode active material of the present invention and other active materials are used in combination, the electrode active material of the present invention is preferably contained in an amount of 10 to 90 parts by mass, more preferably 20 to 80 parts by mass, per 100 parts by mass of the total of the active materials. In this case, as the other active materials, the active materials for the positive electrode and the active materials for the negative electrode described below can be used in combination.

In the case of using the electrode active material according to the present example embodiment only for a positive electrode or only for a negative electrode, as active materials for the other electrode containing no electrode active material according to the present example embodiment, conventionally known ones can be utilized.

For example, in the case of using the electrode active material according to the present example embodiment for the positive electrode, as an active material for the negative electrode, a substance capable of reversibly intercalating and deintercalating lithium ions can be used. Examples of the active material for the negative electrode include metallic lithium, lithium alloys, carbon materials, conductive polymers and lithium oxides. Examples of the lithium alloys include lithium-aluminum alloys, lithium-tin alloys and lithium-silicon alloys. Examples of the carbon materials include graphite, hard carbon and activated carbon. Examples of the conductive polymers include polyacene, polyacetylene, polyphenylene, polyaniline and polypyrrole. Examples of the lithium oxides include oxides of lithium alloys such as lithium aluminum alloys, and lithium titanate.

In the case of using the electrode active material according to the present example embodiment for the negative electrode, as an active material for the positive electrode, a substance capable of reversibly intercalating and deintercalating lithium ions can be used. The active material for the positive electrode includes lithium-containing composite oxides. Specifically, materials such as LiMO₂ (M is selected from Mn, Fe and Co, and a part of M may be replaced with another metal element such as Mg, Al or Ti), LiMn₂O₄ and olivine-type metal phosphate materials can be used.

Although an electrode using the electrode active material according to the present example embodiment is not limited to either of a positive electrode and a negative electrode, from the viewpoint of the energy density, it is preferable to use the electrode active material as an active material for a positive electrode.

(2) Conductive Additive (Auxiliary Conductive Material) and Ionic Conduction Auxiliary Material

The positive electrode and negative electrode, for the purpose of lowering the impedance and improving the energy density and the output characteristic, can also be mixed with a conductive additive (auxiliary conductive material) and an ionic conduction auxiliary material.

The conductive additive includes carbon materials such as graphite, carbon black, acetylene black, carbon fibers and carbon nanotubes, and conductive polymers such as polyaniline, polypyrrole, polythiophene, polyacetylene and polyacene. Among these, the carbon materials are preferable, and specifically, preferable is at least one selected from the group consisting of natural graphite, artificial graphite, carbon black, vapor grown carbon fibers, mesophase pitch carbon fibers and carbon nanotubes. These conductive additives may be used by mixing two or more thereof in any proportions within the scope of the gist of the present invention.

The size of the conductive additive is not especially limited, and finer ones are preferable from the viewpoint of homogeneous dispersion. For example, with respect to the particle diameter, the average particle diameter of primary particles is preferably 500 nm or smaller; and the diameter in the case of a fiber-form or tube-form material is preferably 500 nm or smaller and the length thereof is preferably 5 nm or longer and 50 μm or shorter. Here, the average particle diameter and each size mentioned here are average values obtained by electron microscopic observation, or D50 values in a particle size distribution measured by a laser diffraction-type particle size distribution analyzer.

Examples of the ionic conduction auxiliary materials include a polymer gel electrolyte and a polymer solid electrolyte.

Among these conductive additives and ionic conduction auxiliary materials, it is preferable to mix carbon fibers being a conductive additive. Mixing the carbon fibers makes higher the tensile strength of the electrode and makes scarce the cracking and exfoliation in the electrode. More preferably, vapor grown carbon fibers are mixed.

These conductive additives and ionic conduction auxiliary materials can also each be used singly or as a mixture of two or more. The proportion of these materials in the electrode is preferably 10 to 80% by mass.

(3) Binder

In order to strengthen binding between each material in the positive electrode and negative electrode, a binder can be used. Such a binder includes resin binders such as polytetrafluoroethylene, polyvinylidene fluoride, vinylidene fluoride-hexafluoropropylene copolymers, vinylidene fluoride-tetrafluoroethylene copolymers, styrene-butadiene copolymerized rubber, polypropylene, polyethylene, polyimide, and various polyurethanes. These binders can be used singly or as a mixture of two or more. The proportion of the binders in the electrode is preferably 5 to 30% by mass.

(4) Thickener

In order to make easy the preparation of a slurry for the electrode, a thickener can also be used. Such a thickener includes carboxymethylcellulose, polyethylene oxide, polypropylene oxide, hydroxyethyl cellulose, hydroxypropylcellulose, carboxymethylhydroxyethylcellulose, polyvinyl alcohol, polyacrylamide, hydroxyethyl polyacrylate, ammonium polyacrylate and sodium polyacrylate. These thickeners can be used singly or as a mixture of two or more. The proportion of the thickeners in the electrode is preferably 0.1 to 5% by mass. The thickener further serves as a binder in some cases.

(5) Current Collector

As the negative and positive electrode current collector, those having a shape of a foil, a metal flat plate, a mesh or the like, composed of nickel, aluminum, copper, gold, silver, an aluminum alloy, stainless steel, carbon or the like can be used. Further, the current collector may be made to have a catalytic effect, and the electrode active material and the current collector may also be made to be chemically bound.

(6) Shape of the Secondary Battery

The shape of the secondary battery is not especially limited, and conventionally known ones can be used. The shape of the secondary battery includes shapes in which an electrode stack or a wound body is sealed in a metal case, a resin case, a laminate film composed of a metal foil, such as an aluminum foil, and a synthetic resin film, or the like. Specifically, the secondary battery is fabricated as having a cylindrical, rectangular, coin or sheet shape, but the shape of the secondary battery according to the present example embodiment is not limited to these shapes.

(7) Method for Producing the Secondary Battery

A method for producing the secondary battery is not especially limited, and a method suitably selected according to materials can be used. The method is, for example, such that: a slurry is prepared by adding a solvent to an electrode active material, a conductive additive and the like; then, the obtained slurry is applied on an electrode current collector and the solvent is vaporized by heating or at normal temperature to thereby fabricate an electrode; further the electrode is stacked or wound with a counter electrode and a separator interposed therebetween, and are wrapped in outer packages, and an liquid electrolyte is injected; and the outer packages are sealed. The solvent for slurry includes etheric solvents such as tetrahydrofuran, diethyl ether, ethylene glycol dimethyl ether and dioxane; amine-based solvents such as N,N-dimethylformamide and N-methylpyrrolidone; aromatic hydrocarbon-based solvents such as benzene, toluene and xylene; aliphatic hydrocarbon-based solvents such as hexane and heptane; halogenated hydrocarbon-based solvents such as chloroform, dichloromethane, dichloroethane, trichloroethane and carbon tetrachloride; alkyl ketone-based solvents such as acetone and methyl ethyl ketone; alcoholic solvents such as methanol, ethanol and isopropyl alcohol; and dimethyl sulfoxide and water. Further a method for fabricating an electrode also includes a method in which an electrode active material, a conductive additive and the like are kneaded in a dry condition, and thereafter made into a thin film and laminated on an electrode current collector. In fabrication of an electrode, particularly in the case of the method in which a slurry is prepared by adding a solvent to an organic electrode active material, a conductive additive and the like, and then, the obtained slurry is applied on an electrode current collector and the solvent is vaporized by heating or at normal temperature, exfoliation, cracking and the like of the electrode are liable to occur. The case of fabricating an electrode having a thickness of preferably 40 μm or larger and 300 μm or smaller by using the copolymer according to the present example embodiment as an electrode active material has a feature such that exfoliation, cracking and the like of the electrode hardly occur and a uniform electrode can be fabricated.

When the secondary battery is produced, there are a case where the secondary battery is produced by using, as an electrode active material, the copolymer itself according to the present example embodiment, and a case where the secondary battery is produced by using a polymer which transforms to the copolymer according to the present example embodiment by an electrode reaction. Examples of the polymer which transforms to the copolymer according to the present example embodiment by such an electrode reaction include a lithium salt or a sodium salt composed of nitroxide anions into which nitroxyl radicals have been reduced by reduction of the copolymer represented by the above Formula (1) and electrolyte cations such as lithium ions or sodium ions, and a salt composed of oxoammonium cations into which nitroxyl radicals have been oxidized by oxidation of the copolymer represented by the Formula (1) and electrolyte anions such as PF6⁻ or BF4⁻.

In the present invention, leading-out of terminal from an electrode and other production conditions of outer packages and the like can use methods conventionally known as production methods of secondary batteries.

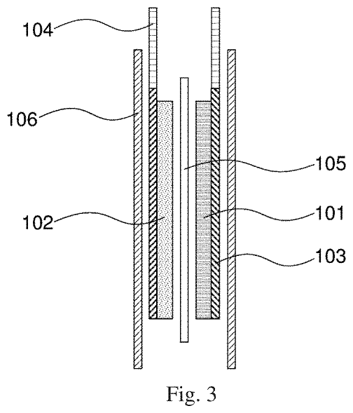

FIG. 2 shows a perspective view of one example of a laminate-type secondary battery according to the present example embodiment; and FIG. 3 shows a cross-sectional view thereof. As shown in these figures, a secondary battery 107 has a stacked structure containing a positive electrode 101, a negative electrode 102 facing the positive electrode, and a separator 105 interposed between the positive electrode and the negative electrode; the stacked structure is covered with outer package films 106; and electrode leads 104 are led out outside the outer package films 106. An electrolyte liquid is injected in the secondary battery. Hereinafter, constituting members and a production method of the laminate-type secondary battery of FIG. 2 will be described in more detail.

### Positive Electrode

The positive electrode 101 includes a positive electrode active material, and as required, further includes a conductive additive and a binder, and is formed on one current collector 103.

### Negative Electrode

The negative electrode 102 includes a negative electrode active material, and as required, further includes a conductive additive and a binder, and is formed on the other current collector 103.

### Separator

Between the positive electrode 101 and the negative electrode 102, an insulating porous separator 105 which dielectrically separate these is provided. As the separator 105, a porous resin film composed of polyethylene, polypropylene or the like, a cellulose membrane, a nonwoven fabric or the like can be used.

### Electrolyte

The electrolyte transports charge carriers between the positive electrode and the negative electrode, and is impregnated in the positive electrode 101, the negative electrode 102 and the separator 105. As the electrolyte, an electrolyte liquid having an ionic conductivity at 20° C. of 10⁻⁵ to 10⁻¹ S/cm, and a nonaqueous electrolyte in which an electrolyte salt is dissolved in an organic solvent can be used. As the solvent for the electrolyte liquid, an aprotic organic solvent can be used.

As the electrolyte salt, a usual electrolyte material such as LiPF₆, LiClO₄, LiBF₄, LiCF₃SO₃, LiN(CF₃SO₂)₂ (hereinafter, “LiTFSI”), LiN(C₂F₅SO₂)₂ (hereinafter, “LiBETI”), Li(CF₃SO₂)₃C or Li(C₂F₅SO₂)₃C can be used.

Examples of the organic solvent include cyclic carbonates such as ethylene carbonate, propylene carbonate and butylene carbonate; linear carbonates such as dimethyl carbonate, diethyl carbonate and methyl ethyl carbonate; y-lactones such as y-butyrolactone; cyclic ether such as tetrahydrofuran and dioxolane; and amides such as dimethylformamide, dimethylacetamide and N-methyl-2-pyrrolidone. As other organic solvents, preferable are organic solvents in which at least one of a cyclic carbonate and a linear carbonate is mixed.

### Outer Package Film

As the outer package films 106, an aluminum laminate film or the like can be used. Outer packages other than the outer package film include metal cases and resin cases. The outer shape of the secondary battery includes cylindrical, rectangular, coin and sheet shapes.

### An Example of Fabricating a Laminate-Type Secondary Battery

A positive electrode 101 was placed on an outer package film 106, and a negative electrode 102 was superimposed thereon through a separator 105 to thereby obtain an electrode stack. The obtained electrode stack was covered with an outer package film 106, and three sides thereof including electrode lead portions were thermally fused. An electrolyte liquid was injected therein and impregnated under vacuum. After the electrolyte liquid was fully impregnated and filled in voids of the electrodes and the separator 105, the remaining fourth side was thermally fused to thereby obtain a laminate-type secondary battery 107.

Here, the “secondary battery” refers to one which can take out an energy electrochemically accumulated, in a form of electric power, and can be charged and discharged. In the secondary battery, a “positive electrode” refers to an electrode whose redox potential is higher, and a “negative electrode” refers to an electrode whose redox potential is conversely lower. The secondary battery according to the present example embodiment is referred to as a “capacitor” in some cases.

### EXAMPLES

Hereinafter, the present invention will be specifically described by way of Examples, but the present invention is not limited to the embodiments shown in the Examples.

### Reference Example 1

Production of Copolymer A

In the production of Copolymer A, 2,2,6,6-tetramethyl-4-piperidylmethacrylate and methacrylic acid were used as a charge ratio of 99:1 in tetrahydrofuran, and a radical polymerization using AIBN (0.1 mol %) as an initiator was carried out at 60° C. for 5 hours to obtain a copolymer represented by the following Formula (7):

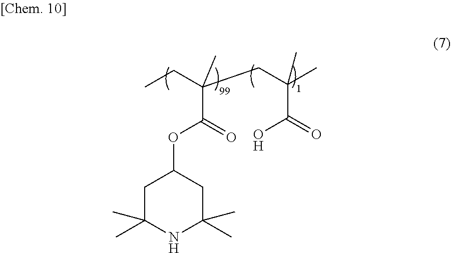

Next, the obtained copolymer (7) was oxidized using hydrogen peroxide solution (30 mol %) as an oxidizing agent at 60° C. for 8 hours to obtain a copolymer represented by the following Formula (3-1) in a red solid (primary average particle diameter: 0.7 μm) state (Mw=270,000).

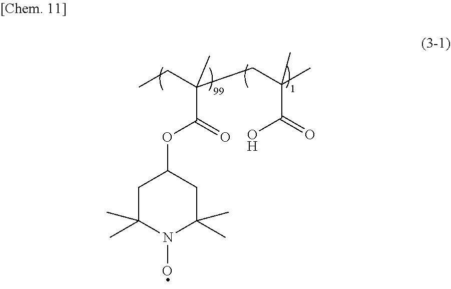

2.1 g of Copolymer A, 0.63 g of VGCF as a conductive additive, 0.24 g of carboxy methylcellulose (CMC) and 0.03 g of polytetrafluoroethylene (PTFE) as binders, and 15 ml of water were stirred by a homogenizer to prepare a uniform slurry. This slurry was applied onto aluminum foil as a positive electrode current collector and dried at 80° C. for 5 minutes. Further, the thickness was adjusted to a range of 140 μm to 150 μm by a roll press to obtain an electrode using the Copolymer A.

### Example 1

In the same manner as in Reference Example 1, but at the time of initial radical polymerization, a crosslinking agent of Formula (8) was added so as to be 1 mol % based on 100 mol % of the total of 2,2,6,6-tetramethyl-4-piperidylmethacrylate and methacrylic acid to obtain a Crosslinked Copolymer B (primary average particle diameter: 12 μm) Using the obtained Crosslinked Copolymer B, an electrode was prepared in the same manner as in Reference Example 1.

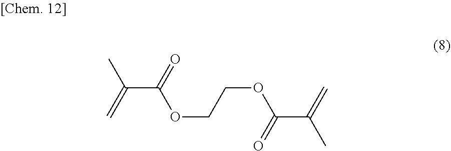

### Example 2

In the same manner as in Example 1, but using a molar ratio of 2,2,6,6-tetramethyl-4-piperidylmethacrylate and methacrylic acid as a 99.25:0.75, a Crosslinked Copolymer C (primary average particle diameter: 12 μm) was obtained. Using the obtained Crosslinked Copolymer C, an electrode was prepared in the same manner as in Reference Example 1.

### Example 3

In the same manner as in Example 1, but using a molar ratio of 2,2,6,6-tetramethyl-4-piperidylmethacrylate and methacrylic acid as a 98.5:1.5, a Crosslinked Copolymer D (primary average particle diameter: 12 μm) was obtained. Using the obtained Crosslinked Copolymer D, an electrode was prepared in the same manner as in Reference Example 1.

### Reference Example 2

A method of manufacturing an organic radical battery using an electrode prepared using Copolymer A as a positive electrode will be described below.

### <Fabrication of Positive Electrode>

The electrode using the Copolymer A produced in Reference Example 1 was cut out into a rectangle of 22 x 24 mm, and then an Al electrode lead was connected by ultrasonic compression bonding to obtain a positive electrode for an organic radical battery.

### <Fabrication of a Negative Electrode>

13.5 g of a graphite powder (particle diameter: 6 μm) as a negative electrode active material, 1.35 g of a polyvinylidene fluoride as a binder, 0.15 g of a carbon black as a conductivity additive and 30 g of an N-methylpyrrolidone solvent (boiling point: 202° C.) were stirred in a homogenizer to thereby prepare a homogeneous slurry. The slurry was applied on a copper mesh being a negative electrode current collector, and dried at 120° C. for 5 min. Further, the thickness of the resultant was regulated in the range of 50 μm to 55 μm by a roll press machine. An obtained negative electrode was cut out into a rectangle of 22×24 mm; and a nickel electrode lead was connected to the copper mesh by ultrasonic compression bonding to thereby make a negative electrode for the organic radical battery.

### <Fabrication of Laminated Batteries>

A porous polypropylene film separator was interposed between the positive electrode and the negative electrode to thereby obtain an electrode stack. The electrode stack was covered with aluminum laminate outer packages; and three sides thereof including electrode lead portions were thermally fused. A mixed electrolyte liquid, of ethylene carbonate/dimethyl carbonate in 40/60 (v/v) containing a LiPF₆ supporting salt of 1.0 mol/L in concentration, was injected through the remaining fourth side in the outer packages, allowing the electrodes to be well impregnated therewith. The amount of the electrolyte liquid contained at this time was regulated so that the molar concentration of the lithium salt became 1.5 times the number of moles of the nitroxyl radical moiety structure. The remaining fourth side was thermally fused under reduced pressure to thereby fabricate a laminate-type organic radical battery.

### <Measurement of Discharge Characteristics>

The fabricated organic radical battery was charged until the voltage became 4 V and thereafter discharged to 3 V, at a constant current of 0.25 mA in a thermostatic chamber at 20° C.; and then, the discharge characteristic of the organic radical battery was measured.

Evaluation of the discharge rate characteristic: the battery was charged at a constant current of 2.5 mA until the voltage became 4 V, and thereafter successively charged at a constant voltage of 4 V until the current became 0.25 mA; thereafter, the battery was discharged at constant currents in varied magnitudes of the discharge current, and the discharge capacities at the times were measured. The above discharges of the constant currents were at three currents of 1C (2.5 mA), 10C (25 mA) and 20C (50 mA). Here, the discharge capacities were, in order to easily compare efficiencies of the radical materials, determined as capacities per weight of the radical materials.

Measurement of the output in pulse discharge: the battery was charged at a constant current of 2.5 mA until the voltage became 4 V, thereafter successively charged at a constant voltage of 4 V until the current became 0.25 mA, and thereafter charged at a constant current of 2.5 mA until the voltage became 4 V; and thereafter successively, the battery was subjected to a 1-sec pulse discharge at varied current values in the range of 10.5 mA to 950 mA, and the voltages at the ends of the discharges were measured. The cell resistance was determined from a gradient of a voltage-current curve and the maximum output was determined from a current-output (voltage×current) curve. Here, the maximum output was determined as an output per positive electrode area. Evaluation results of the discharge rate characteristic and measurement results of the output in pulse discharge are shown in Table 1.

<Measurement of Cycle Characteristics>

The produced organic radical battery was charged in a constant temperature bath at 20° C. with a constant current of 1.25 mA (0.5C) until the voltage reached 4V, and then discharged to 3V with a constant current of 2.5 mA (1.0C). This was repeated 500 times to measure cycle characteristics. The first discharge capacity and the 500-th discharge capacity are shown in Table 1. Note that the discharge capacity was determined as the capacity per weight of the radical material to facilitate comparison of the efficiency of the radical material.

### Examples 4-6

An organic radical battery was produced in the same manner as in Reference Example 2 except that the electrodes produced in Examples 1 to 3 were used instead of the electrodes produced in Reference Example 1, and the discharge rate characteristics, pulse output characteristics, and cycle characteristics were measured. The results are given in Table 1.

### Comparative Example 1

An electrode was prepared in the same manner as in the method described in Reference Example 1, except that a PTMA (Mw=89,000, referred to as Polymer E) having the structure of Formula (2) was used. Using the positive electrode manufactured using the polymer E, the organic radical battery was manufactured, and the discharge rate characteristics, pulse output characteristics, and cycle characteristics were measured in the same manner as in the method described in Reference Example 2. The results are given in Table 1.

### Comparative Example 2

A Crosslinked Polymer F of PTMA was produced in the same manner as in the process described in Example 1, except that methacrylic acid was not used to prepare an electrode. Further, using a positive electrode prepared using the Crosslinked Polymer F, in the same manner as in the method described in Reference Example 2, the preparation of an organic radical battery and the measurement of the discharge rate characteristics, the pulse output characteristics, and the cycle characteristics were performed. The results are given in Table 1.

TABLE 1

| | | | Discharge Rate | | | Pulse Power | | Cycle | |
|---|---|---|---|---|---|---|---|---|---|
| | | | Characteristics | | | Characteristics | | Characteristics | |
| | | | 1^{C} | 10^{C} | 20^{C} | Cell | Maximum | (mAh/g) | |
| | Radical | (1-a):(1-b) | capacity | capacity | capacity | resistance | power | First | 500-th |
| | material | (Mole ratio) | (mAh/g) | (mAh/g) | (mAh/g) | (Ωcm²) | (mW/cm²) | capacity | capacity |
| Reference | Copolymer A | 99.0:1.0 | 85 | 71 | 67 | 7.3 | 440 | 85 | 65 |
| Example 2 | | | | | | | | | |
| Example 4 | Crosslinked | 99.0:1.0 | 98 | 94 | 89 | 7.3 | 454 | 97 | 89 |
| | copolymer B | | | | | | | | |
| Example 5 | Crosslinked | 99.25:0.75 | 98 | 85 | 81 | 7.4 | 450 | 98 | 89 |
| | copolymer C | | | | | | | | |
| Example 6 | Crosslinked | 98.5:1.5 | 91 | 88 | 85 | 8.1 | 422 | 97 | 88 |
| | copolymer D | | | | | | | | |
| Comparative | Polymer E | — | 73 | 56 | 38 | 16.8 | 180 | 73 | 59 |
| Example 1 | | | | | | | | | |
| Comparative | Crosslinked | — | 60 | 32 | 21 | 29.8 | 108 | 62 | 45 |
| Example 2 | copolymer F | | | | | | | | |

### INDUSTRIAL APPLICABILITY

According to the organic radical battery of the present invention, it is possible to provide a secondary battery having both excellent cycle characteristics and high discharge characteristics. Therefore, the organic radical battery obtained according to an example embodiment of the present invention, an electric vehicle, a storage power supply for driving or auxiliary such as a hybrid electric vehicle, a power supply of various portable electronic devices, a power storage device of various energies such as solar energy or wind power, or the like of a household electric appliance it can be applied to the power source or the like.

While the present invention has been described with reference to Examples of Embodiments, the present invention is not limited to the above Examples of Embodiments. Various changes which can be understood by those skilled in the art within the scope of the present invention can be made in the configuration and details of the present invention.

This application claims priority to Japanese Patent Application No. 2018-135495, filed Jul. 19, 2018, the entire disclosure of which is incorporated herein by reference.

### DESCRIPTION OF SYMBOLS

101 POSITIVE ELECTRODE

102 NEGATIVE ELECTRODE

103 CURRENT COLLECTOR

104 ELECTRODE LEAD

105 SEPARATOR

106 OUTER PACKAGE FILM

107 LAMINATE-TYPE SECONDARY BATTERY

What is claimed is:

1. An electrode comprising, as an electrode active material, a copolymer comprising a repeating unit having a nitroxide radical site represented by the following Formula (1-a) and a repeating unit having a carboxyl group represented by the following Formula (1-b) in a range in which x satisfies 0.1 to 10, and the copolymer having a crosslinked structure: 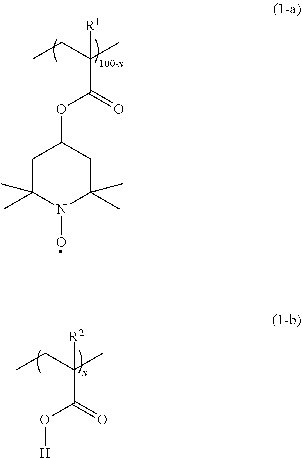
wherein wherein in Formulas (1-a) and (1-b), R¹ and R² each independently represent hydrogen or a methyl group; and x represents a mol % of Formula (1-b) in the total 100 mol % of Formulas (1-a) and (1-b).

2. The electrode according to claim 1, wherein the crosslinked structure is at least one of crosslinked structural units represented by the following Formulas (1-c) and (1-d): 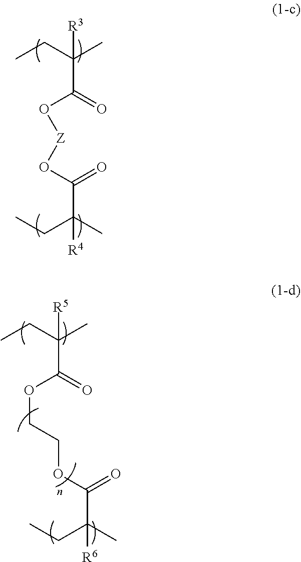
wherein in Formulas (1-c) and (1-d), R³ to R⁶ each independently represent hydrogen or a methyl group; Z represents an alkylene chain having 2 to 12 carbon atoms and n represents an integer of 1 to 12.

3. The electrode according to claim 1, wherein the crosslinked structure is contained in a range of 5 mol % or less based on a total of 100 mol % of the Formulas (1-a) and (1-b).

4. The electrode according to claim 1 wherein the copolymer having the crosslinked structure has a primary average particle diameter in the form of a powder in the range of 0.01 μm to 50 μm.

5. A secondary battery comprising an electrode according to claim 1 for a positive electrode, for a negative electrode or for both positive and negative electrodes.

6. A secondary battery comprising an electrode according to claim 2 for a positive electrode, for a negative electrode or for both positive and negative electrodes.

7. A secondary battery comprising an electrode according to claim 3 for a positive electrode, for a negative electrode or for both positive and negative electrodes.

8. A secondary battery comprising an electrode according to claim 4 for a positive electrode, for a negative electrode or for both positive and negative electrodes.

9. The electrode according to claim 2, wherein the crosslinked structure is contained in a range of 5 mol % or less based on a total of 100 mol % of the Formulas (1-a) and (1-b).

10. A secondary battery comprising an electrode according to claim 9 for a positive electrode, for a negative electrode or for both positive and negative electrodes.

11. The electrode according to claim 2, wherein the copolymer having the crosslinked structure has a primary average particle diameter in the form of a powder in the range of 0.01 μm to 50 μm.

12. A secondary battery comprising an electrode according to claim 11 for a positive electrode, for a negative electrode or for both positive and negative electrodes.

13. The electrode according to claim 3, wherein the copolymer having the crosslinked structure has a primary average particle diameter in the form of a powder in the range of 0.01 μm to 50 μm.

14. A secondary battery comprising an electrode according to claim 13 for a positive electrode, for a negative electrode or for both positive and negative electrodes.
